(19) United States
(12) Patent Application Publication
(10) Pub. No.: US 2010/0290850 A1
(43) Pub. Date: Nov. 18, 2010

(54) BORING ARRANGEMENT TO BE CONNECTED TO A BORING MACHINE

(75) Inventors: Jürgen STOLTE, Bad Malente (DE); Wolfgang GAUL, Hamburg (DE); Axel Homann, Hamburg (DE)

Correspondence Address: INGRASSIA FISHER & LORENZ, P.C., 7010 E. COCHISE ROAD, SCOTTSDALE, AZ, 85253, US

(73) Assignee: AIRBUS OPERATIONS GMBH, Hamburg (DE)

(21) Appl. No.: 12/789,310

(22) Filed: May 27, 2010

Related U.S. Application Data
(63) Continuation of application No. PCT/EP2007/063033, filed on Nov. 29, 2007.

(51) Int. Cl. B23B 51/00

(52) U.S. Cl. 408/202

(57) ABSTRACT

A boring arrangement is adapted to be connected to a boring machine. The boring arrangement includes, but is not limited to a boring bit for boring a final hole or a countersink hole in a hole of a workpiece with a fastening portion adapted to be secured to the boring machine. A stopping element is also included that is movably connected to the boring bit so as to enable a relative motion in a boring feed advance direction and with an end facing away from the fastening portion and further an element movable to the boring bit so as to enable a relative motion in the boring feed advance direction. The element has a hollow interior space therein adapted to allow the boring bit to pass therethrough in the boring feed advance direction so as to contact the workpiece and bore a final hole or a countersink hole therein. The element includes, but is not limited to an end facing towards to the stopping element. At this end, the element includes, but is not limited to a pin element at the second end facing towards to the workpiece to get in contact with preferably the most distant part of the border area of the hole of the workpiece regarding said direction.

### CROSS-REFERENCE TO RELATED APPLICATIONS

This is a continuation of International Application No. PCT/EP2007/063033, filed Nov. 29, 2007, which is hereby incorporated by reference in its entirety.

### TECHNICAL FIELD

The present invention relates to a boring arrangement for boring a final hole or a countersink hole in a workpiece, preferably of an aircraft.

### BACKGROUND

For better aerodynamic efficiency and balance of aircrafts it is preferred to optimize the aerodynamic shape of each workpiece that offers an outer surface. Less attention to those circumstances causes more fuel consumption and therefore higher costs of flights.

Therefore, the smallest extension of the rived heads of a workpiece such as the part of a wing of an aircraft, even with less than a millimeter, should be avoided. Each final hole or countersink hole have to be bored very precisely an exactly, even and particularly at non-planar surfaces of said workpieces. The mechanical boring process for tens or hundreds of final holes or countersink holes for rivets with different size, length and angle to surface is very time consuming and vulnerable for errors of the worker.

In view of the foregoing, it is at least one object of the invention to provide a less time consuming and simple boring device for boring final holes and countersink holes in a workpiece with exact length, particularly regarding to a non-planar workpiece of an aircraft. Further, in view of the above it is another object of the invention to provide a boring arrangement, which can considerably reduce the assembly time and effort involved in joining together components having overlapping joint surfaces, especially with a great number of rivet holes that must be bored and rivet connections that must be set therein. In addition, other objects, desirable features, and characteristics may become apparent from the subsequent summary and detailed description, and the appended claims, taken in conjunction with the accompanying drawings and this background.

### SUMMARY

The above objects, other objects, desirable features, and characteristics, have been achieved according to at least one embodiment of the invention in a boring arrangement adapted to be connected to and used together with a boring machine. The boring arrangement comprising: a boring bit or drill bit, especially a countersink bit for boring a final hole or a countersink hole in a hole of a workpiece with a fastening portion adapted to be secured to the boring machine; a stopping element that is movably connected to the boring bit so as to enable a relative motion in a boring feed advance direction and at an end facing away from said fastening portion; and an element movable to the boring bit so as to enable a relative motion in said boring feed advance direction, and that has a hollow interior space therein adapted to allow the boring bit to pass therethrough in said boring feed advance direction so as to contact the workpiece and bore a final hole or a countersink hole therein, wherein the element comprising a first end facing towards to the said stopping element, and wherein the element comprising a pin element at a second end facing towards to said workpiece to get in contact with preferably the most distant part of the border area of said hole of the said workpiece.

The said pin element is generally in contact with the said border area during the whole boring process. The length of the final hole or the countersink hole is generally measured from the contact end of the pin element, which should be exactly the most distant part of the workpiece surface near the hole more particular the planned final hole or countersink hole- to the end of the countersink hole or the final hole/the depth of the workpiece.

According to an embodiment of the invention, it is especially advantageous if said element is insertable into a bearing bush affixed in a boring template to reduce the assembly time once more.

According to an embodiment of the invention the said element is affixably connected in a predefined position to the said bearing bush.

Regarding the combination or interaction between the boring arrangement and the boring machine, various embodiments are possible. For example, the boring arrangement may generally be arranged as an accessory on the front or working end of the boring machine, whereby the boring bit is secured with a fastening portion to the boring machine.

The stopping element is mounted to the boring bit preferably by means of a clamping screw or other fastening devices.

The wished length of the final hole or the countersink hole is adjustable by moving, preferably rotating, the stopping element in the boring feed advance direction. The bore process stops the final length of the bore hole is reached if the said stopping element and the end of the said element facing towards to the said stopping element are in contact.

It should be noted that the term “comprising” does not exclude other elements and the “a” or “an” does not exclude a plurality. It should also be noted that reference signs in the claims shall not be construed as limiting the scope of the claims.

### BRIEF DESCRIPTION OF THE DRAWINGS

In order that the invention may be clearly understood, it will now be described in connection with at least one example embodiment, with references to the accompanying drawings:

FIG. 1 is a schematic side view of an embodiment of a boring arrangement according to an embodiment of the invention; and

FIG. 2 is a profile view of a non planar workpiece with a final hole and a countersink hole.

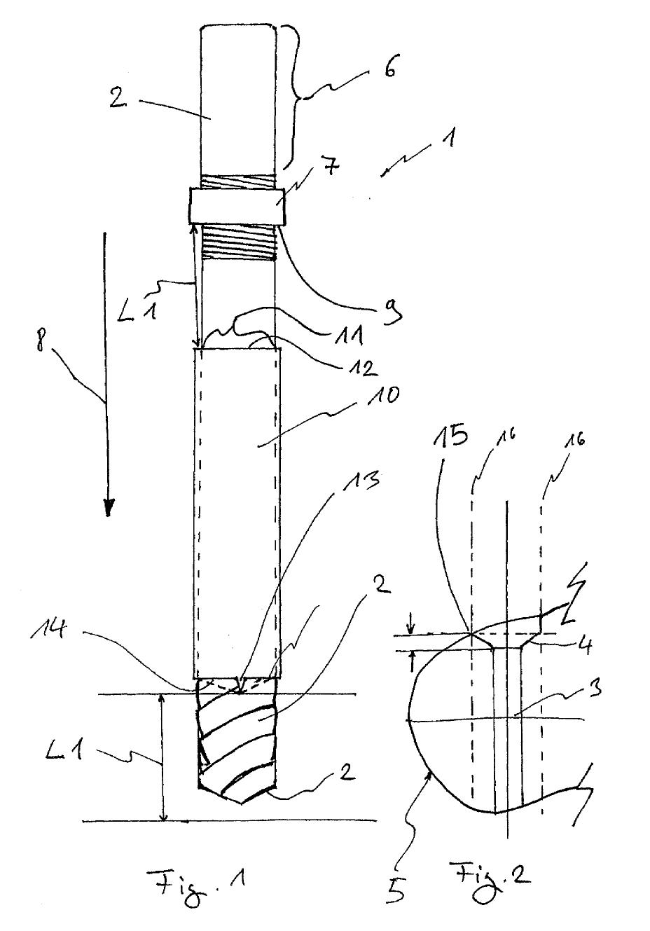

### DETAILED DESCRIPTION

The following detailed description of the invention is merely exemplary in nature and is not intended to limit application and uses. Furthermore, there is no intention to be bound by any theory presented in the preceding background or summary or the following detailed description.

A boring arrangement 1 is adapted to be connected to a boring machine, not shown here. The boring arrangement 1 comprises a boring bit 2 for boring a final hole 3 and/or a countersink hole 4 (FIG. 2) in a hole of a workpiece 5. The boring bit 2 has a fastening portion 6 adapted to be secured to the boring machine. A stopping element 7 is movably connected to the boring bit 2 so as to enable a relative motion in a boring feed advance direction 8 and at an end 9 facing away from said fastening portion 6.

Further the boring arrangement 1 offers an element 10 movable to the boring bit 2 so as to enable a relative motion in the boring feed advance direction 8, and that has a hollow interior space 11 therein adapted to allow the boring bit 2 to pass therethrough in said boring feed advance direction 8 so as to contact the workpiece 5 and bore a final hole 3 or a countersink hole 4 therein, wherein the element 10 comprising an end 12 facing towards to the said stopping element 7, and wherein the element 10 comprising a pin element 13 at a second end 14 facing towards to said workpiece 5 to get in contact with preferably the most distant part 15 of the border area 16 of said hole of the said workpiece regarding said boring feed advance direction 8. The element 10 is insertable into a bearing bush, not shown here, that is affixed in a boring template, even not shown. Furthermore the element 10 has fixing means 17 and is connectable in a predefined position to the said bearing bush. The drilling arrangement 1 allows to bore a borehole with exact length L1 and therefore preserves that no rivet head or other fixing element extends over the workpiece 5.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing summary and detailed description will provide those skilled in the art with a convenient road map for implementing an exemplary embodiment of the invention, it being understood that various changes may be made in the function and arrangement of elements described in an exemplary embodiment without departing from the scope as set forth in the appended claims and their legal equivalents.

What claimed is:

1. A boring arrangement adapted to be connected to a boring machine, said boring arrangement comprising:
a boring bit adapted for boring a first hole in a second hole of a workpiece with a fastening portion adapted to be secured to the boring machine;
a stopping element that is movably connected to the boring bit so as to enable a relative motion in a boring feed advance direction and with a first end facing away from said fastening portion; and
an element movable to the boring bit so as to enable the relative motion in said boring feed advance direction, and that has a hollow interior space therein adapted to allow the boring bit to pass therethrough in said boring feed advance direction so as to contact said workpiece and bore the first hole therein, wherein the element comprising a second end facing towards to the said stopping element, and wherein the element comprising a pin element at a third end facing towards to said workpiece to get in contact with a most distant part of a border area of said second hole of the said workpiece regarding said boring feed advance direction.

2. The boring arrangement according to claim 1, wherein said element is insertable into a bearing bush affixed in a boring template.

3. The boring arrangement according to claim 2, wherein said element is affixably connected in a predefined position to the said bearing bush.

4. The boring arrangement according to claim 1, wherein the first hole is a final hole.

5. The boring arrangement according to claim 1, where the first hole is a countersink hole.

6. The boring arrangement according to claim 1, wherein the workpiece is an aircraft.
